(19) United States
(12) Patent Application Publication
(10) Pub. No.: US 2026/0356096 A1
(43) Pub. Date: Nov. 12, 2026

(54) LIQUID DISCHARGE HEAD, LIQUID DISCHARGE UNIT, AND LIQUID DISCHARGE APPARATUS

(71) Applicants: Yuki FUJIMURA, Kanagawa (JP); Keishi MIWA, Kanagawa (JP)

(72) Inventors: Yuki FUJIMURA, Kanagawa (JP); Keishi MIWA, Kanagawa (JP)

(21) Appl. No.: 19/671,283

(22) Filed: May 8, 2026

(30) Foreign Application Priority Data
May 12, 2025 (JP) 2025-079548

(51) Int. Cl. B41J 2/165; B41J 2/14

(52) U.S. Cl. CPC B41J 2/16502; B41J 2/14274; B41J 2/1433; B41J 2/16507

(57) ABSTRACT

A liquid discharge head includes: a channel forming member having multiple liquid chambers; and a nozzle plate having a first face joined to the channel forming member, the nozzle plate having: a water-repellent region including a water-repellent layer on a second face opposite the first face; a non-water-repellent region other than the water-repellent region on the second face; and multiple nozzles in the water-repellent region, the multiple nozzles respectively communicating with the multiple liquid chambers to discharge a liquid in a discharge direction; and a cover joined to the non-water-repellent region of the nozzle plate in the discharge direction with an adhesive, wherein the adhesive covers: a first portion in the non-water-repellent region between the cover and the nozzle plate in the discharge direction; and a second portion at an end portion of the water-repellent region of the nozzle plate.

### CROSS-REFERENCE TO RELATED APPLICATIONS

This patent application is based on and claims priority pursuant to 35 U.S.C. § 119(a) to Japanese Patent Application No. 2025-079548, filed on May 12, 2025, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

As a liquid discharge apparatus that discharges liquid, there is an inkjet image forming apparatus that discharges ink onto a sheet or the like as a discharge target medium to form an image.

An inkjet image forming apparatus includes a liquid discharge head having multiple nozzles for discharging ink. When a sheet as a discharge target medium is conveyed to a position facing the liquid discharge head, ink is discharged from multiple nozzles, and an image is formed on the sheet.

When the sheet comes into contact with the nozzle, water repellency in the vicinity of the nozzle may be deteriorated, or the nozzle may be damaged and stable ink discharge may not be possible.

### SUMMARY

The present disclosure described herein provides a liquid discharge head including: a channel forming member having multiple liquid chambers; and a nozzle plate having a first face joined to the channel forming member, the nozzle plate having: a water-repellent region including a water-repellent layer on a second face opposite the first face; a non-water-repellent region other than the water-repellent region on the second face; and multiple nozzles in the water-repellent region, the multiple nozzles respectively communicating with the multiple liquid chambers to discharge a liquid in a discharge direction; and a cover joined to the non-water-repellent region of the nozzle plate in the discharge direction with an adhesive, wherein the adhesive covers: a first portion in the non-water-repellent region between the cover and the nozzle plate in the discharge direction; a second portion at an end portion of the water-repellent region of the nozzle plate; and a third portion at an end face of the cover.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a front view of a liquid discharge unit;

FIG. 1B is a side view of the liquid discharge unit;

FIG. 1C is a front view of a liquid discharge head;

FIG. 1D is a perspective view of the liquid discharge head;

FIG. 1E is a cross-sectional view taken along line 1E-1E of the liquid discharge head of FIG. 1C;

FIG. 1F is a plan view of a nozzle plate of the liquid discharge head;

FIG. 2A-a is an exploded perspective view of a nozzle plate and a cover of the liquid discharge head according to a first embodiment;

FIG. 2A-b is a plan view of a state in which the nozzle plate and the cover are joined; FIG. 2A-c is an enlarged cross-sectional view taken along line 2C-2C of FIG. 2A-b;

FIG. 2B-a is an enlarged cross-sectional view of the liquid discharge head according to the first embodiment;

FIG. 2B-b is an enlarged cross-sectional view of a liquid discharge head according to a modified embodiment;

FIG. 3A is an exploded perspective view of a nozzle plate and a cover of a liquid discharge head according to a second embodiment;

FIG. 3B is a plan view of the nozzle plate and the cover joined together;

FIG. 3C is an enlarged cross-sectional view of the nozzle plate;

FIG. 4 is an enlarged cross-sectional view of a nozzle plate of a liquid discharge head according to a third embodiment;

FIG. 5 is a plan view of a nozzle plate of a liquid discharge head according to another embodiment;

FIG. 6A is an enlarged cross-sectional view of a nozzle plate of a liquid discharge head as a first comparative example;

FIG. 6B is an enlarged cross-sectional view of a nozzle plate of a liquid discharge head as a second comparative example;

FIG. 7 is a diagram illustrating an inkjet image forming apparatus;

FIG. 8 is a plan view of a serial type head unit; and

FIG. 9 is a plan view of a nozzle plate of the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Liquid Discharge Unit

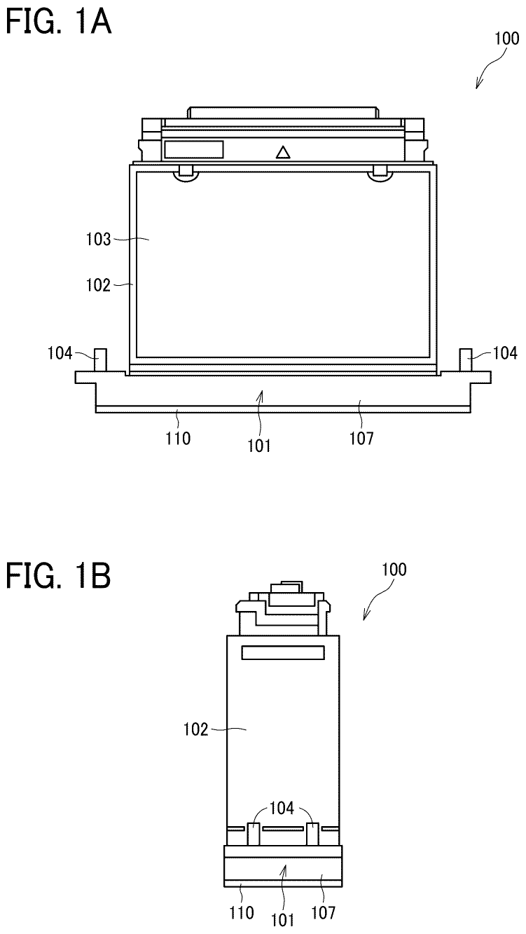

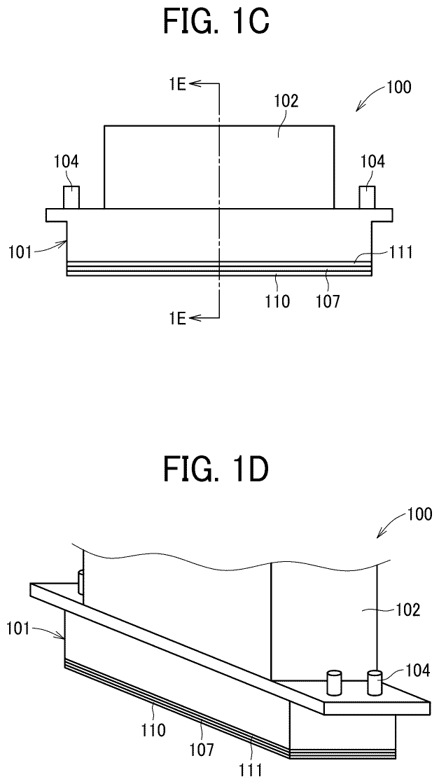

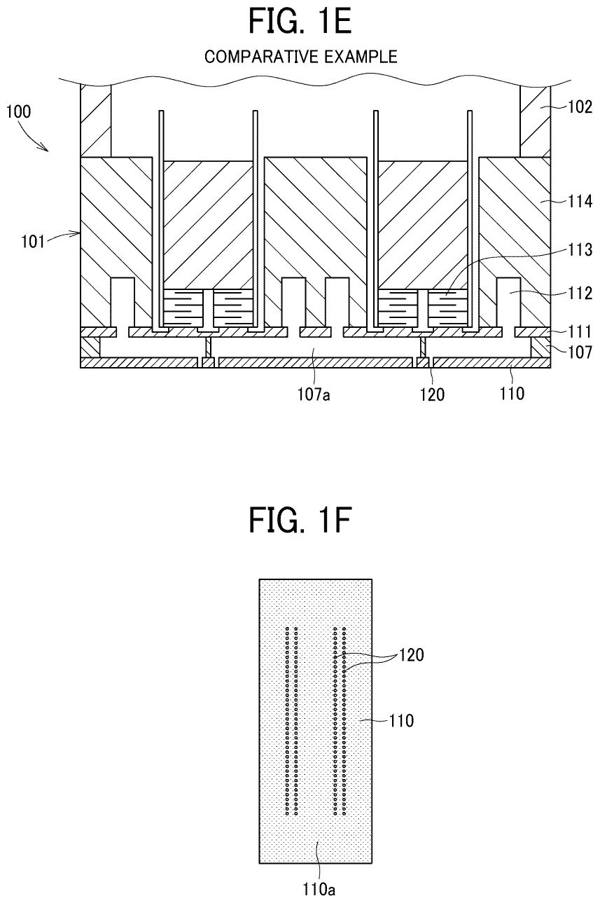

The present embodiment will be described below with reference to the drawings. As illustrated in FIGS. 1A and 1B, the liquid discharge unit 100 includes a liquid discharge head 101 that discharges liquid, a main body cover 102, a heat sink 103 as a heat dissipation member, and the like. The heat sink 103 can be formed of a metal member or a resin such as a polycarbonate resin having high thermal conductivity.

As illustrated in FIGS. 1A to 1D, the liquid discharge head 101 includes a liquid inlet/outlet port 104 through which liquid such as ink flows in and out, a channel forming member 107 forming a channel through which liquid supplied from the liquid inlet/outlet port 104 passes, and a nozzle plate 110. The channel forming member 107 can be formed by subjecting a steel use stainless (SUS) substrate to etching with an acidic etching solution or machining such as punching.

As illustrated in FIG. 1E, a diaphragm 111 is stacked on the channel forming member 107. Multiple actuators formed of laminated piezoelectric elements 113 is disposed on the diaphragm 111. The common channel member 114 on the diaphragm 111 forms a channel 112.

Inside the channel forming member 107, multiple liquid chambers 107a are formed corresponding to the respective piezoelectric elements 113. The liquid chamber 107a is connected to the channel 112 of the common channel member 114.

As illustrated in FIG. 1F, multiple nozzle arrays are formed on the nozzle plate 110. As illustrated in FIG. 1E, individual nozzles 120 of respective nozzle arrays communicate with the liquid chambers 107a of the channel forming member 107.

A water-repellent region 110a having a water-repellent layer is formed on the face of the nozzle plate 110. The nozzle 120 is formed in the water-repellent region 110a.

The amount of ink droplets ejected from the nozzle 120 and controllability of the discharge direction can be enhanced by the water-repellent region 110a. The water-repellent layer can be formed by, for example, coating the face of the nozzle plate 110 with a fluorine-based material by a dry process as described in Japanese Unexamined Patent Application Publication No. 58-175666, or coating the face of the nozzle plate 110 with a fluorine-based material by a wet process as described in Japanese Unexamined Patent Application Publication No. 60-201956.

As a comparative example, the nozzle plate 110 is disposed on the outermost side of the liquid discharge unit 100 as illustrated in FIG. 1E. Due to this, at the time of printing on a sheet serving as a discharge target medium for ink from the nozzles 120, there is a problem that the water-repellent layer in the vicinity of the nozzles 120 is damaged by collision between the nozzle plate 110 and the sheet, and the water repellency is deteriorated.

Nozzle plate of liquid discharge head

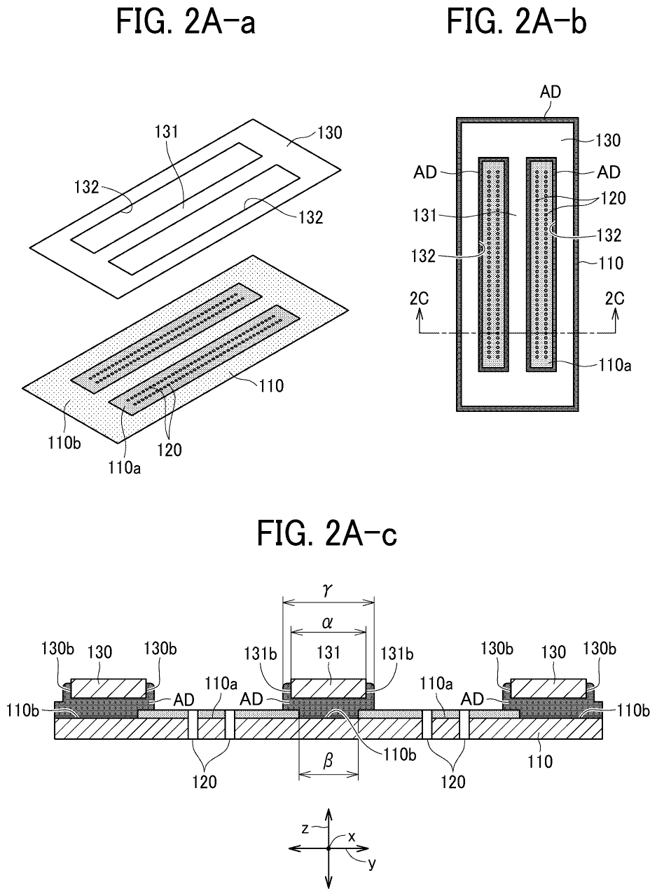

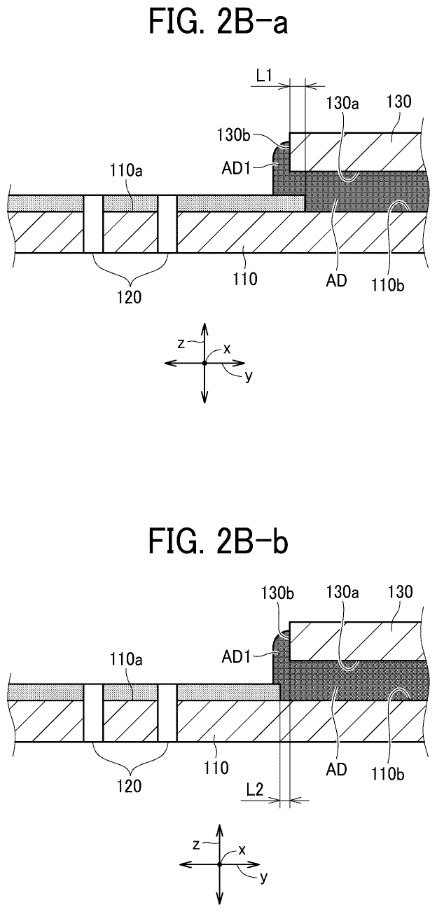

FIG. 2A-a to 2A-c illustrates a first embodiment of the liquid discharge head 101. Multiple arrays of nozzles 120 are formed at the center of the nozzle plate 110 of the liquid discharge head 101. In the illustrated example, two pairs of nozzle arrays are formed, each pair including two nozzle arrays. The configuration of the nozzle arrays is arbitrary, and a configuration other than the pair of two nozzle arrays may be adopted.

The water-repellent region 110a is formed in two arrays corresponding to each set of nozzle arrays. A region other than the water-repellent region 110a, that is, an intermediate portion between the peripheral edge of the nozzle plate 110 and the two sets of nozzle arrays is a non-water-repellent region 110b having no water-repellent layer. The non-water-repellent region 110b can be formed by masking the water-repellent region 110a of the nozzle plate 110 and subjecting the entire nozzle plate 110 to plasma treatment (water-repellent region removal treatment).

A cover 130 is joined to the non-water-repellent region 110b via an adhesive layer made of an adhesive AD. The cover 130 is smaller than the nozzle plate 110 and has a planar shape without unevenness. The cover 130 includes a partition 131 that covers an intermediate portion of the two pairs of nozzle arrays, and openings 132 that open the two pairs of nozzles to the outside. The openings 132 can be formed by etching the base material of the cover 130 with an acidic etching solution or machining such as punching.

In the cover 130, an alloy film and a water-repellent layer are sequentially formed on the entire surface of the base material made of the same material as the nozzle plate 110 and the channel forming member 107. The alloy film can be made of Si, Ta, Zr, or the like. Since the channel forming member 107, the nozzle plate 110, and the cover 130 are made of the same material (having the same coefficient of linear expansion), it is possible to suppress distortion at the time of joining.

At the time of assembling the liquid discharge head 101, the entire surface of the water-repellent layer on the side of the cover 130 joined to the channel forming member 107 is removed by plasma treatment (rendered non-water-repellent). On the other hand, the entire surface on the side not joined to the channel forming member 107 is in a state where the water-repellent layer remains.

The water repellency after the plasma treatment can be determined by measuring the amount of fluorine on the face of the water-repellent region 110a by a surface analysis method such as X-ray photoelectron spectroscopy (XPS). It is also possible to confirm the quality of water repellency by comparing face wettability by the contact angle of the water-repellent region 110a or the like.

As illustrated in FIG. 2A-c, a part of the adhesive AD between the non-water-repellent region 110b and the cover 130 (including the partition 131) creeps up to the end face 130b of the cover 130 beyond the boundary between the water-repellent region 110a and the non-water-repellent region 110b. At least a part of the end face 130b of the cover 130 is covered with the adhesive AD that has crept up. The creeping amount of the adhesive AD can be adjusted by changing at least one of the application position of the adhesive AD, the application amount of the adhesive AD, or the pressurizing force when the cover 130 is joined.

As described above, by covering the end face 130b of the cover 130 with the adhesive AD, it is possible to prevent the ink from entering an inner face 130a of the cover 130 from the end face 130b, and the cover 130 from being peeled off by an impact force (media attack) of the sheet or the like acting on the end face 130b.

As illustrated in FIG. 2B-a, an end of the cover 130 can protrude to the water-repellent region 110a by a horizontal length L1. That is, the end of the cover 130 can extend beyond the boundary between the water-repellent region 110a and the non-water-repellent region 110b toward the water-repellent region 110a by the length L1.

As described above, by extending the end of the cover 130 by the length L1, the adhesive AD that has crept up to the end face 130b of the cover 130 can be received by the water-repellent layer of the water-repellent region 110a, and the holding property or the wettability and spreadability of the adhesive AD on the end face 130b can be improved. The end face 130b can be protected by the adhesive AD against ink, media attack, wiping, and the like.

As illustrated in FIG. 2B-b, the end of the cover 130 can be set back by a length L2 from the boundary between the water-repellent region 110a and the non-water-repellent region 110b. Thus, the adhesive AD that has crept up to the end face 130b of the cover 130 is received by the non-water-repellent region 110b of the nozzle plate 110, whereby the holding property or the wettability and spreadability of the adhesive AD on the end face 130b can be improved. The end face 130b can be protected by the adhesive AD against ink, media attack, wiping, and the like.

### Partition

For the partition 131 of the cover 130 that partitions the arrays of the multiple arrays of the nozzles 120, the longitudinal direction of the row of the nozzles 120 is x, a direction orthogonal to x (the width direction of the partition 131) is y, and a direction orthogonal to xy (the thickness direction of the partition 131) is z. When the width of the non-water-repellent region 110b in the y direction is β, the width of the partition 131 is α, and the width of the adhesive AD is γ, the width α is included in the range of the width γ and the width β is included in the range of the width α.

A part of the adhesive AD within the range of the width β protrudes into the water-repellent region 110a and creeps up in the z direction to the end face of the partition 131. Therefore, at least a part of the end face of the partition 131 is easily covered with the adhesive AD crept up in the z direction. Thus, the end face of the partition 131 can be protected against ink, media attack, wiping, and the like.

### Peripheral Water-Repellent Region

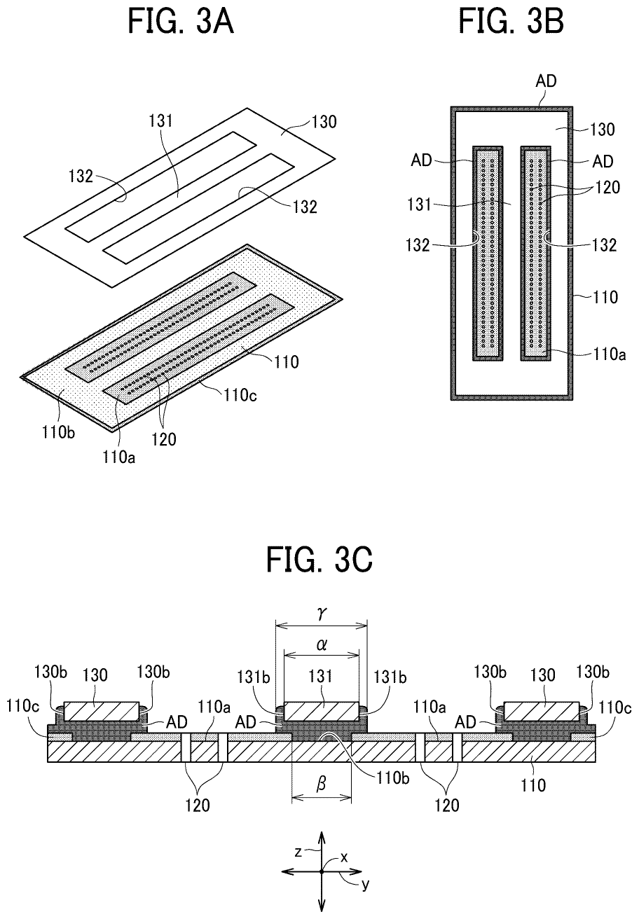

FIGS. 3A to 3C illustrates a second embodiment of the liquid discharge head 101. In the second embodiment, an elongated peripheral water-repellent region 110c is formed on the outer periphery of the non-water-repellent region 110b at the peripheral edge of the nozzle plate 110. By forming the peripheral water-repellent region 110c, in the peripheral edge of the nozzle plate 110, the adhesive AD that has crept up to the outer peripheral end face 130b of the cover 130 can be received by the peripheral water-repellent region 110c, and the holding property or the wettability and spreadability of the adhesive AD on the outer peripheral end face 130b can be improved.

### End Face with Tapered Face

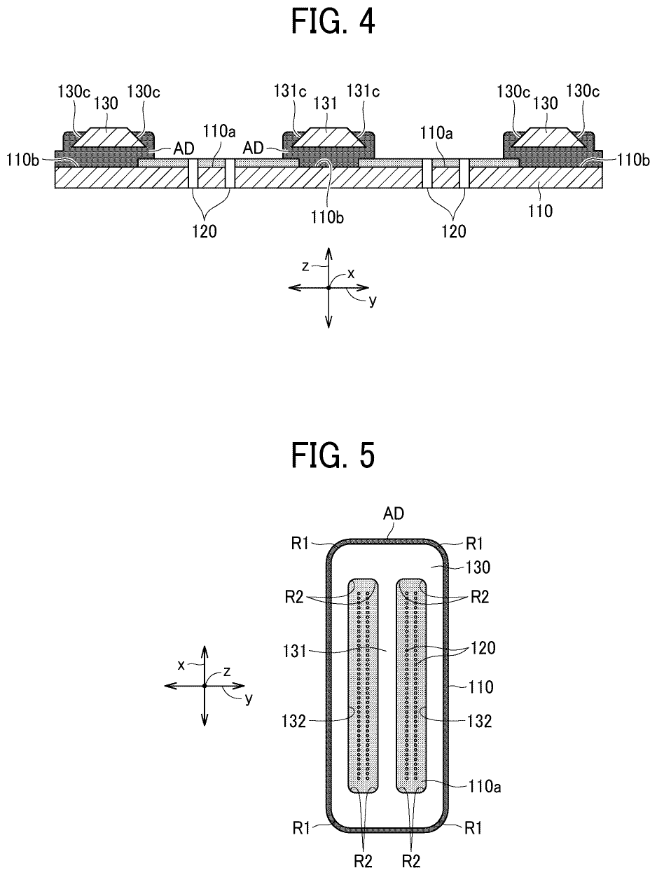

FIG. 4 illustrates a third embodiment of the liquid discharge head 101. In the third embodiment, the end face of the cover 130 is formed with a tapered face 130c. The inclination direction of the tapered face 130c is a direction in which the adhesive AD that has crept up to the tapered face 130c which is the end face of the cover 130 is scooped up.

Thus, the holding property or wettability and spreadability of the adhesive AD on the tapered face 130c can be improved. The tapered face 130c can be protected by the adhesive AD against ink, media attack, wiping, and the like.

In FIG. 5, four corners of the outer shape of the rectangular nozzle plate 110 and the cover 130 are each formed at an outer angle R1, and four corners of the left and right openings 132 of the cover 130 are each formed at an inner angle R2. That is, the nozzle plate 110, the cover 130, and the opening 132 have round corner rectangular shapes. Each of the external angle R1 and the internal angle R2 can be formed of a ¼ arc.

The outer angle R1 makes it possible to improve the creeping property of the adhesive AD with respect to an outer end face of the cover 130 and to reduce the peel ability of the corner portion of the cover 130 together with a pressure dispersion effect due to the media attack. The inner angle R2 can suppress accumulation of ink and foreign matter at the four corners of the opening 132 of the cover 130, and can lower the peel ability at the four corners of the cover 130.

### Comparative Example

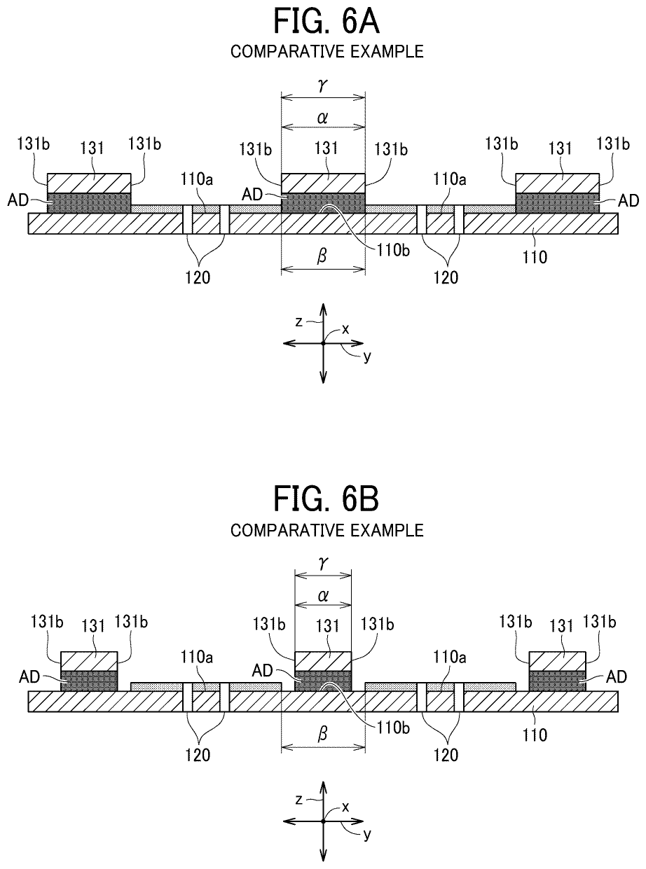

FIGS. 6A and 6B illustrate a first comparative example and a second comparative example. In the first comparative example of FIG. 6A, the width α, the width β, and the width γ have the same length. In this case, the adhesive AD between the non-water-repellent region 110b of the nozzle plate 110 and the partition 131 of the cover 130 cannot creep up to the end face 131b of the partition 131. Therefore, the peel ability of the cover 130 cannot be reduced. Ink is likely to accumulate in the non-water-repellent region 110b on the outer periphery of the cover 130, which causes a disadvantage in ink resistance.

In the second comparative example of FIG. 6B, the width α and the width β are included in the range of the width β, and the width α is equal to the width β. Also in this case, the adhesive AD between the non-water-repellent region 110b of the nozzle plate 110 and the partition 131 of the cover 130 cannot creep up to the end face 131b of the partition 131. Therefore, the peel ability of the cover 130 cannot be reduced. Ink is likely to accumulate in the non-water-repellent regions 110b on both sides of the partition 131 and the non-water-repellent region 110b on the outer periphery of the cover 130, which causes a disadvantage in ink resistance.

### Image Forming Apparatus

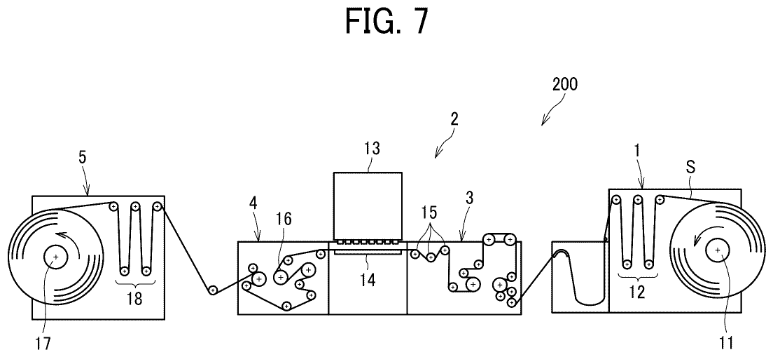

FIG. 7 is an example of an image forming apparatus 200 as a liquid discharge apparatus including the head unit 13 as a liquid discharge unit described above. The image forming apparatus 200 includes a sheet feeding unit 1 that supplies a sheet S for image formation, an image forming unit 2 that forms an image on the sheet S, a conveyance unit 3 that conveys the sheet S to the image forming unit 2, a drying unit 4 that dries the sheet S, and a sheet collection unit 5 that collects the sheet S on which an image is formed. The image forming apparatus 200 according to the present embodiment includes a control unit that controls the sheet feeding unit 1, the image forming unit 2, the conveyance unit 3, the drying unit 4, and the sheet collection unit 5.

The sheet feeding unit 1 includes a feeding roller 11 in which a long sheet S is wound in a roll shape, and a tension adjustment mechanism 12 that adjusts tension applied to the sheet S. The feeding roller 11 is rotatable in the direction indicated by an arrow illustrated in FIG. 7, and the sheet S is fed out as the feeding roller 11 rotates.

The tension adjustment mechanism 12 includes multiple rollers between which the sheet S is stretched to apply tension to the sheet S. Some of the multiple rollers move to adjust the tension of the sheet S, and the sheet S is fed from the feeding roller 11 with a constant tension.

The image forming unit 2 includes a head unit 13 that discharges liquid ink onto the sheet S, and a platen 14 as a sheet supporting member that supports the conveyed sheet S. The head unit 13 includes multiple liquid discharge heads.

An image is formed on the sheet S by discharging ink from each liquid discharge head onto the sheet S based on the image data generated by the control unit of the image forming apparatus 200. The ink is a liquid containing a colorant, a solvent, and crystalline resin particles dispersed in the solvent.

The crystalline resin is a resin that undergoes a phase change when heated to a predetermined melting point or higher and melts into a liquid from a crystalline state. The platen 14 is disposed in such a way as to face the head unit 13, and supports a lower face of the sheet S fed from the sheet feeding unit 1. The platen 14 approaches and separates from the head unit 13 so as to keep the distance between the head unit 13 and the sheet S constant.

The conveyance unit 3 includes multiple conveyance rollers 15. The sheet S is conveyed to the image forming unit 2 as each of the conveyance rollers 15 rotates in a state where the sheet S is stretched over each of the conveyance rollers 15. The conveyance unit 3 may include other conveyors such as a conveyance belt.

The drying unit 4 includes a heating drum 16 that heats the sheet S to promote drying of the ink on the sheet S. The heating drum 16 is a cylindrical member that rotates while the sheet S is wound around an outer peripheral face, and a heating source such as a halogen heater is disposed inside. A non-contact heating unit such as a hot air generating device that blows hot air to the sheet S can be used as a heating unit to heat the sheet S in addition to a contact heating unit such as the heating drum 16.

The sheet collection unit 5 includes a collection roller 17 and a tension adjustment mechanism 18. The collection roller 17 winds and collects the sheet S. The tension adjustment mechanism 18 adjusts tension to be applied to the sheet S. The collection roller 17 is rotatable in the direction indicated by an arrow illustrated in FIG. 17, and the sheet S is wound in a roll shape around the collection roller 17 as the collection roller 17 rotates.

The tension adjustment mechanism 18 includes multiple rollers, similar to the tension adjustment mechanism 12 of the sheet feeding unit 1. Some of the multiple rollers move to adjust the tension of the sheet S, and the sheet S is wound up by the collection roller 17 with a constant tension.

The control unit of the image forming apparatus 200 includes an information processing apparatus such as a personal computer (PC). The control unit generates image data to be formed on the sheet S, and controls various operations of the sheet feeding unit 1, the image forming unit 2, the conveyance unit 3, the drying unit 4, and the sheet collection unit 5. For example, the control unit controls the temperatures of the heating source that heats the heating drum 16 in addition to the rotation speeds of the feeding roller 11, the collection roller 17, and the conveyance rollers 15.

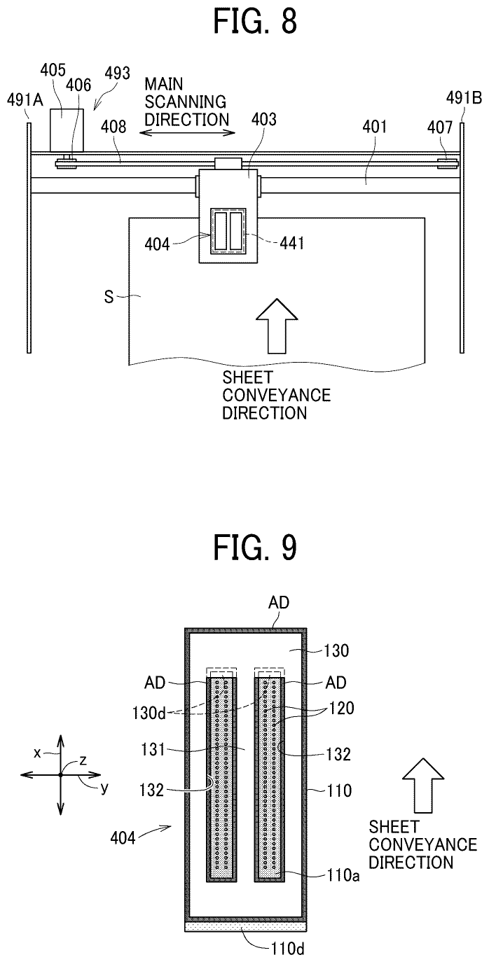

FIG. 8 is a plan view of an image forming apparatus including a serial type liquid discharge head 404. The carriage 403 to which the liquid discharge head 404 is attached reciprocates in a main scanning direction (left-right direction in FIG. 8) by a main scanning movement mechanism 493.

The main scanning movement mechanism 493 includes a guide member 401, a main scanning motor 405, a timing belt 408, and the like. The guide member 401 is bridged between left and right side plates 491A and 491B, and holds the carriage 403 so as to be movable in the main scanning direction. The main scanning motor 405 reciprocally moves the carriage 403 in the main scanning direction via the timing belt 408 bridged between a driving pulley 406 and a driven pulley 407.

The carriage 403 is formed by integrating the liquid discharge head 404 and the head tank 441 according to the present embodiment. The liquid discharge head 404 discharges color liquids of, for example, yellow (Y), cyan (C), magenta (M), and black (K).

The liquid discharge head 404 includes a nozzle row including multiple nozzles arrayed in a sub scanning direction perpendicular to the main scanning direction and is mounted so that a discharge direction is downward. For example, the above-described liquid discharge head 101 can be used as the liquid discharge head 404. By providing the liquid discharge head 101 according to the present embodiment, a high quality image can be stably formed.

### Formation of Protrusion in Consideration of Sheet Conveyance Direction

FIG. 9 illustrates a configuration of the nozzle plate 110 and the cover 130 in consideration of the conveyance direction of the sheet S. At the front end of the liquid discharge head 404 located on the upstream side in the conveyance direction of the sheet S, which is a discharge target medium, the nozzle plate 110 has a protrusion 110d protruding to the upstream side in the conveyance direction with respect to the cover 130.

Due to the presence of the protrusion 110d of the nozzle plate 110, it is possible to prevent the sheet S from coming into contact with the upstream end of the cover 130 in the conveyance direction and damaging and peeling the upstream end. Since the protrusion 110d of the nozzle plate 110 does not have the nozzle 120, there is no particular disadvantage even if the sheet S comes into contact with the nozzle plate.

Further, at the rear end of the liquid discharge head 404 located on the downstream side in the conveyance direction of the sheet S, which is a discharge target medium, the cover 130 has a protrusion 130d protruding to the upstream side in the conveyance direction from the nozzle plate 110. Since there is no possibility that the sheet S collides with the protrusion 130d on the downstream side in the conveyance direction, it is possible to prioritize an increase in the bonding area and an increase in the bonding strength of the cover 130 by the protrusion 130d.

Although the present embodiment has been specifically described based on the embodiments, the present embodiment is not limited to the embodiments, and it goes without saying that various modifications can be made within the scope of the technical idea described in the claims. For example, when the number of nozzle arrays of the nozzle plate 1110 is large, two or more partitions 131 of the cover 130 may be formed, and conversely, when the number of nozzle arrays is small, the partition 131 of the cover 130 may be omitted.

A liquid discharge head (101, 404) includes: a channel forming member (107) having multiple liquid chambers (107a); and a nozzle plate (110) having a first face joined to the channel forming member (107), the nozzle plate (110) having: a water-repellent region (110a) including a water-repellent layer on a second face opposite the first face; a non-water-repellent region (110b) other than the water-repellent region (110a) on the second face; and multiple nozzles (120) in the water-repellent region (110a), the multiple nozzles (120) respectively communicating with the multiple liquid chambers (107a) to discharge a liquid in a discharge direction (z); and a cover (130) joined to the non-water-repellent region (110b) of the nozzle plate (110) in the discharge direction (z) with an adhesive (AD), wherein the adhesive (AD) covers: a first portion in the non-water-repellent region (110b) between the cover (130) and the nozzle plate (110) in the discharge direction (z); a second portion at an end portion of the water-repellent region (110a) of the nozzle plate (110); and a third portion at an end face (131b) of the cover (130).

The first portion is disposed between the non-water-repellent region (110b) of the nozzle plate (110) and the cover (130) in the discharge direction, the first portion extending in a width direction (y) perpendicular to the discharge direction (z); the second portion is disposed at the end portion of the water-repellent region (110a) of the nozzle plate (110) outside the first portion in the width direction (y); and the third portion: covers the end face (131b) of the cover (130) at each end of the cover (130) in the width direction; and extends from the second portion in the discharge direction along the end face (131b) of the cover (130). The end face (131b) of the cover (130) protrudes toward the water-repellent region (110a) beyond a boundary between the water-repellent region (110a) and the non-water-repellent region (110b) in a width direction (y) perpendicular to the discharge direction (z). The third portion of the adhesive (AD) is disposed on the water-repellent layer at an edge of the water-repellent region (110a).

A liquid discharge head (101, 404) further includes: multiple nozzle arrays each including having the multiple nozzles arrayed in a longitudinal direction (x) perpendicular to the discharge direction (z) and a width direction (y) perpendicular to the discharge direction (z) and the longitudinal direction (x) in the water-repellent region; and the cover including: multiple openings (132) exposing the multiple nozzle arrays from the opening; and a partition (131) partitioning the multiple openings, the partition (131) has an end face at each end of the partition in the width direction (y), wherein a following relationship is satisfied: γ >α >β, where: α is a first width of the partition in the width direction (y); β is a second width of the non-water-repellent region (110b) in the width direction (y); and γ is a third width of the adhesive (AD) in the width direction (y), the first width (α) is arranged within a range of the third width (γ), and the second width (β) is arranged within a range of the first width (α), and the adhesive (AD) extends in the discharge direction to cover the at least a part of the end face (131b) of the partition (131).

The nozzle plate (110) has a peripheral water-repellent region (110c) on an outer periphery of the second face of the nozzle plate (110) outside the non-water-repellent region (110a), the cover (130) further includes a peripheral edge surrounding an outer periphery of the cover (130), wherein the adhesive (AD) extends: in the width direction beyond a boundary between the non-water-repellent region (110b) and the peripheral water-repellent region (110c) toward the peripheral edge (130b) of the cover (130) in the width direction (y), and in the discharge direction to cover at least a part of the peripheral edge (130b) of the cover (130). The channel forming member (107), the nozzle plate (110), and the cover are made of the same material.

The cover has: a water repellent face including water-repellent layer; and a non-water-repellent face opposite the non-water-repellent face, the water repellent face joined to the channel forming member (107), and the non-water-repellent face subjected to a water-repellent treatment from which the water-repellent layer is removed. The nozzle plate (110) has a rounded rectangular outer peripheral shape; the cover (130) has a rounded rectangular outer peripheral shape; and each of the multiple openings (132) of the cover (130) has a rounded rectangular inner peripheral shape.

A liquid discharge unit (100) includes the liquid discharge head (101, 404). A liquid discharge apparatus includes: the liquid discharge head (101, 404); and a conveyor (3) to convey a medium to the liquid discharge head (101, 404) in a conveyance direction. The cover has a first upstream end in an opposite direction opposite to the conveyance direction, the nozzle plate (110) has a second upstream end protruding from the first upstream end in the opposite direction. The nozzle plate (110) has a first downstream end in the conveyance direction, the cover has an opening having a second downstream end in the conveyance direction, and the second downstream end protrudes away from the first downstream end in an opposite direction opposite to the conveyance direction.

### Supplementary Note

Hereinafter, preferred aspects of the present embodiment will be additionally described.

### Aspect 1

According to Aspect 1, a liquid discharge head includes: a channel forming member having multiple liquid chambers; and a nozzle plate joined to the channel forming member, the nozzle plate having a water-repellent region having a water-repellent layer on a face on a side opposite to the channel forming member and a non-water-repellent region other than the water-repellent region, multiple nozzles communicating with the liquid chambers being formed in the water-repellent region, a cover that protects the nozzle plate via an adhesive being joined to the non-water-repellent region,
a part of the adhesive between the non-water-repellent region and the cover creeping up to an end face of the cover beyond a boundary between the non-water-repellent region and the water-repellent region, at least a part of the end face of the cover being covered with the adhesive that has crept up.

### Aspect 2

According to Aspect 2, in the liquid discharge head of Aspect 1, an end face of the cover protrudes toward the water-repellent region beyond a boundary between the water-repellent region and the non-water-repellent region.

### Aspect 3

According to Aspect 3, in the liquid discharge head of Aspect 1 or 2, a part of the adhesive that has crept up is received by a water-repellent layer at an edge of the water-repellent region.

### Aspect 4

According to Aspect 4, a liquid discharge head includes: a channel forming member having multiple liquid chambers; and a nozzle plate joined to the channel forming member, the nozzle plate having a water-repellent region having a water-repellent layer on a face on a side opposite to the channel forming member and a non-water-repellent region other than the water-repellent region, multiple nozzles communicating with the liquid chambers being formed in multiple arrays in the water-repellent region, a cover that protects the nozzle plate via an adhesive being joined to the non-water-repellent region,
the cover including a partition that partitions arrays of the multiple arrays of nozzles, and
with a longitudinal direction of the row as x, a direction orthogonal to the x as y, a width of the non-water-repellent region in the y direction as β, a width of the partition as α, and a width of the adhesive as γ, all between the arrays of the multiple arrays of nozzles, the width α being included in a range of the width γ and the width β being included in a range of the width α, a part of the adhesive within the range of the width β creeping up to an end face of the partition, at least a part of the end face of the partition being covered with the adhesive that has crept up.

### Aspect 5

According to Aspect 5, a liquid discharge head includes: a channel forming member having multiple liquid chambers; and a nozzle plate joined to the channel forming member, the nozzle plate having a water-repellent region having a water-repellent layer on a face on a side opposite to the channel forming member and a non-water-repellent region other than the water-repellent region, multiple nozzles communicating with the liquid chambers being formed in multiple arrays in the water-repellent region, a cover that protects the nozzle plate via an adhesive being joined to the non-water-repellent region,
the cover including a partition that partitions arrays of the multiple arrays of nozzles and a peripheral edge that surrounds an outer periphery except between the arrays of the multiple arrays of nozzles,
with a longitudinal direction of the row as x, a direction orthogonal to the x as y, a width of the non-water-repellent region in the y direction as β, a width of the partition as α, and a width of the adhesive as γ, all between the arrays of the multiple arrays of nozzles, the width α being included in a range of the width γ and the width β being included in a range of the width α, a part of the adhesive within the range of the width β creeping up to an end face of the partition, at least a part of the end face of the partition being covered with the adhesive that has crept up,
a peripheral water-repellent region being formed outside the non-water-repellent region formed on an outer peripheral face of the nozzle plate facing the peripheral edge, a part of the adhesive between the peripheral edge and the non-water-repellent region creeping up to an end face of the peripheral edge beyond a boundary between the non-water-repellent region and the peripheral water-repellent region, at least a part of the end face of the peripheral edge being covered with the adhesive that has crept up.

### Aspect 6

According to Aspect 6, a liquid discharge head includes: a channel forming member having multiple liquid chambers; and a nozzle plate joined to the channel forming member, the nozzle plate having a water-repellent region having a water-repellent layer on a face on a side opposite to the channel forming member and a non-water-repellent region other than the water-repellent region, multiple nozzles communicating with the liquid chambers being formed in multiple arrays in the water-repellent region, a cover that protects the nozzle plate via an adhesive being joined to the non-water-repellent region,
the cover including a partition that partitions arrays of the multiple arrays of nozzles and a peripheral edge that surrounds an outer periphery except between the arrays of the multiple arrays of nozzles,
with a longitudinal direction of the row as x, a direction orthogonal to the x as y, a width of the non-water-repellent region in the y direction as β, a width of the partition as α, and a width of the adhesive as γ, all between the arrays of the multiple arrays of nozzles, the width α being included in a range of the width γ and the width β being included in a range of the width α, a part of the adhesive within the range of the width β creeping up to an end face of the partition, at least a part of the end face of the partition being covered with the adhesive that has crept up,
a peripheral water-repellent region being formed outside the non-water-repellent region formed on an outer peripheral face of the nozzle plate facing the peripheral edge, a part of the adhesive between the peripheral edge and the non-water-repellent region creeping up to an end face of the peripheral edge beyond a boundary between the non-water-repellent region and the peripheral water-repellent region, at least a part of the end face of the peripheral edge being covered with the adhesive that has crept up,
the end face of the partition and the end face of the peripheral edge being formed of tapered faces inclined in a direction in which the adhesive that has crept up is scooped up.

### Aspect 7

According to Aspect 7, in the liquid discharge head of any one of Aspects 1 to 6, the channel forming member, the nozzle plate, and the cover are made of the same material.

### Aspect 8

According to Aspect 8, in the liquid discharge head of any one of Aspects 1 to 7, a face of the cover excluding a face joined to the channel forming member is subjected to a water-repellent treatment.

### Aspect 9

According to Aspect 9, in the liquid discharge head of any one of Aspects 1 to 8, an outer peripheral shape of the nozzle plate and the cover and an inner peripheral shape of an opening surrounded by a partition and a peripheral edge of the cover are rounded rectangles.

### Aspect 10

According to Aspect 10, a liquid discharge unit includes: the liquid discharge head of any one of Aspects 1 to 9.

### Aspect 11

According to Aspect 11, a liquid discharge apparatus includes: the liquid discharge head of any one of Aspects 1 to 9.

### Aspect 12

According to Aspect 12, in the liquid discharge apparatus of Aspect 11, the nozzle plate protrudes upstream of the cover in a conveyance direction at a front end of the liquid discharge head located upstream in the conveyance direction of a discharge target medium.

### Aspect 13

According to Aspect 13, in the liquid discharge apparatus of Aspect 11, the cover protrudes upstream of the nozzle plate in a conveyance direction at a rear end of the liquid discharge head located downstream in the conveyance direction of a discharge target medium.

1. A liquid discharge head comprising:
a channel forming member having multiple liquid chambers; and
a nozzle plate having a first face joined to the channel forming member, the nozzle plate having:
a water-repellent region including a water-repellent layer on a second face opposite the first face;
a non-water-repellent region other than the water-repellent region on the second face; and
multiple nozzles in the water-repellent region, the multiple nozzles respectively communicating with the multiple liquid chambers to discharge a liquid in a discharge direction; and
a cover joined to the non-water-repellent region of the nozzle plate in the discharge direction with an adhesive,
wherein the adhesive covers:
a first portion in the non-water-repellent region between the cover and the nozzle plate in the discharge direction;
a second portion at an end portion of the water-repellent region of the nozzle plate; and
a third portion at an end face of the cover.

2. The liquid discharge head according to claim 1,
wherein the first portion is disposed between the non-water-repellent region of the nozzle plate and the cover in the discharge direction,
the first portion extending in a width direction perpendicular to the discharge direction;
the second portion is disposed at the end portion of the water-repellent region of the nozzle plate outside the first portion in the width direction; and
the third portion:
covers the end face of the cover at each end of the cover in the width direction; and
extends from the second portion in the discharge direction along the end face of the cover.

3. The liquid discharge head according to claim 1,
wherein the end face of the cover protrudes toward the water-repellent region beyond a boundary between the water-repellent region and the non-water-repellent region in a width direction perpendicular to the discharge direction.

4. The liquid discharge head according to claim 1,
wherein the third portion of the adhesive is disposed on the water-repellent layer at an edge of the water-repellent region.

5. The liquid discharge head according to claim 1, further comprising:
multiple nozzle arrays each including having the multiple nozzles arrayed in a longitudinal direction perpendicular to the discharge direction and a width direction perpendicular to the discharge direction and the longitudinal direction in the water-repellent region; and
the cover including:
multiple openings exposing the multiple nozzle arrays from the opening; and
a partition partitioning the multiple openings, the partition has an end face at each end of the partition in the width direction,
wherein a following relationship is satisfied: γ>α>β,
where:
α is a first width of the partition in the width direction;
β is a second width of the non-water-repellent region in the width direction; and
γ is a third width of the adhesive in the width direction,
the first width is arranged within a range of the third width,
the second width is arranged within a range of the first width, and
the adhesive extends in the discharge direction to cover the at least a part of the end face of the partition.

6. The liquid discharge head according to claim 5,
wherein the nozzle plate has a peripheral water-repellent region on an outer periphery of the second face of the nozzle plate outside the non-water-repellent region,
the cover further includes a peripheral edge surrounding an outer periphery of the cover,
wherein the adhesive extends:
in the width direction beyond a boundary between the non-water-repellent region and the peripheral water-repellent region toward the peripheral edge of the cover in the width direction, and
in the discharge direction to cover at least a part of the peripheral edge of the cover.

7. The liquid discharge head according to claim 6,
wherein the end face of the partition and the end face of the peripheral edge being formed of tapered faces inclined in a direction in which the adhesive that has crept up is scooped up.

8. The liquid discharge head according to claim 1,
wherein the channel forming member, the nozzle plate, and the cover are made of the same material.

9. The liquid discharge head according to claim 1,
wherein the cover has:
a water repellent face including water-repellent layer; and
a non-water-repellent face opposite the non-water-repellent face,
the water repellent face joined to the channel forming member, and
the non-water-repellent face subjected to a water-repellent treatment from which the water-repellent layer is removed.

10. The liquid discharge head according to claim 5,
wherein the nozzle plate has a rounded rectangular outer peripheral shape;
the cover has a rounded rectangular outer peripheral shape; and
each of the multiple openings of the cover has a rounded rectangular inner peripheral shape.

11. A liquid discharge unit comprising the liquid discharge head according to claim 1.

12. A liquid discharge apparatus comprising:
the liquid discharge head according to claim 1; and
a conveyor to convey a medium to the liquid discharge head in a conveyance direction.

13. The liquid discharge apparatus according to claim 12,
wherein the cover has a first upstream end in an opposite direction opposite to the conveyance direction, and
the nozzle plate has a second upstream end protruding from the first upstream end in the opposite direction.

14. The liquid discharge apparatus according to claim 12,
wherein the nozzle plate has a first downstream end in the conveyance direction,
the cover has an opening having a second downstream end in the conveyance direction, and
the second downstream end protrudes away from the first downstream end in an opposite direction opposite to the conveyance direction.
